(19) United States
(12) Patent Application Publication
(10) Pub. No.: US 2017/0190071 A1
(43) Pub. Date: Jul. 6, 2017

(54) CUTTING APPARATUS

(71) Applicant: BROTHER KOGYO KABUSHIKI KAISHA, Nagoya (JP)

(72) Inventor: Daisuke Abe, Nagoya (JP)

(21) Appl. No.: 15/467,562

(22) Filed: Mar. 23, 2017

Related U.S. Application Data
(63) Continuation of application No. PCT/JP2016/058099, filed on Mar. 15, 2016.

(30) Foreign Application Priority Data
Mar. 23, 2015 (JP) 2015-059484

(51) Int. Cl. B26D 5/00; B26F 1/44; G05B 19/18; B26D 7/26

(52) U.S. Cl. CPC B26D 5/007; B26D 5/005; B26D 7/2614; B26F 1/44; G05B 19/182; B26F 2001/4481; B26F 2210/12; G05B 2219/32423

(57) ABSTRACT

A cutting apparatus including a cutting mechanism configured to cut a workpiece, the cutting apparatus includes a controller being configured to control the cutting apparatus to: generate image data by reading a pattern from a surface of the workpiece; generate cut data used for causing the cutting mechanism to cut the pattern, on the basis of the image data; store the cut data; judge whether or not a volume of the cut data exceeds a predetermined threshold value; divide the cut data into sections each having a volume equal to or smaller than the threshold value when determined that the volume of the cut data exceeds the threshold value; and cause the storage unit to store therein a plurality of divided sections of cut data, which is a result of the cut data being divided.

### CROSS-REFERENCE TO RELATED APPLICATION

This application is a continuation application of International Application No. PCT/JP2016/058099, filed on Mar. 15, 2016, which claims priority from Japanese Patent Application No. 2015-059484, filed on Mar. 23, 2015. The disclosure of the foregoing application is hereby incorporated by reference in its entirety.

### FIELD

The disclosure relates to a cutting apparatus including a cutting mechanism configured to cut a workpiece such as paper, cloth, or the like, on the basis of cut data.

### BACKGROUND

Conventionally, a known cutting apparatus is configured to cause a cutting mechanism to cut a sheet-like workpiece such as paper, cloth, or the like into a predetermined shape, on the basis of cut data. Further, the cutting apparatus is provided with a scanner unit so as to be able to read a pattern drawn on a surface of the workpiece. Further, the cutting apparatus is configured to generate the cut data on the basis of image data of the read pattern. In addition, the cutting apparatus is also capable of storing the cut data into a storage unit and editing the cut data.

### SUMMARY

When the scanner unit included in the cutting apparatus described above reads the pattern from the surface of the workpiece, the volume of the image data (and therefore the volume of the cut data) tends to be large, when the pattern has a complicated shape or when the reading resolution of the scanner unit is high. When the volume of the cut data is large, there are some situations where the processing amount may exceed a processing limit, due to a restriction from the capacity of the internal memory that is included in the cutting apparatus and is used for processing the cut data or a restriction from the performance level of a CPU or the like. In that situation, a problem may arise where it is not possible to store the cut data into the storage unit or where it is not possible to cut the workpiece in a single process or the like.

It is an object of the present disclosure to provide a cutting apparatus that makes it possible to store cut data generated on the basis of image data of a pattern read by a scanner unit into a storage unit even when the volume of the cut data exceeds a predetermined level and makes it possible to cut the pattern in a single process on the basis of the cut data.

To achieve the object described above, a cutting apparatus according to aspects of the disclosure including a cutting mechanism configured to cut a workpiece includes: a controller, the controller being configured to control the cutting apparatus to: generate image data by reading a pattern from a surface of the workpiece; generate cut data used for causing the cutting mechanism to cut the pattern, on the basis of the image data; store the cut data; judge whether or not a volume of the cut data exceeds a predetermined threshold value; divide the cut data into sections each having a volume equal to or smaller than the threshold value when determined that the volume of the cut data exceeds the threshold value; and cause the storage unit to store therein a plurality of divided sections of cut data, which is a result of the cut data being divided.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 illustrates a first embodiment of the disclosure and is a schematic perspective view of an external appearance of a cutting apparatus.

FIG. 2 is a plan view of an internal structure of the cutting apparatus.

FIG. 3 is a front view of a cut head part.

FIG. 4 is a front view of a cutter cartridge.

FIG. 5 is a block diagram illustrating an electrical configuration of the cutting apparatus.

FIG. 6 is a flowchart illustrating a main processing procedure performed by a control circuit.

FIG. 7 is a first flowchart illustrating a procedure in a cut data dividing process.

FIG. 8 is a second flowchart illustrating the procedure in the cut data dividing process.

FIG. 9A is a first drawing for explaining a method for appending label information.

FIG. 9B is a second drawing for explaining the method for appending the label information.

FIG. 9C is a third drawing for explaining the method for appending the label information

FIG. 9D is a fourth drawing for explaining the method for appending the label information.

FIG. 9E is a fifth drawing for explaining the method for appending the label information.

FIG. 9F is a sixth drawing for explaining the method for appending the label information.

FIG. 9G is a seventh drawing for explaining the method for appending the label information.

FIG. 9H is an eighth drawing for explaining the method for appending the label information.

FIG. 9I is a ninth drawing for explaining the method for appending the label information.

FIG. 9J is a tenth drawing for explaining the method for appending the label information.

FIG. 10 illustrates a second embodiment of the disclosure and is a first flowchart illustrating a procedure in a cut data dividing process.

FIG. 11 is a second flowchart illustrating the procedure in the cut data dividing process.

FIG. 12A is a first drawing for explaining a method for dividing cut data.

FIG. 12B is a second drawing for explaining the method for dividing the cut data.

FIG. 12C is a third drawing for explaining the method for dividing the cut data.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

### (1) First Embodiment

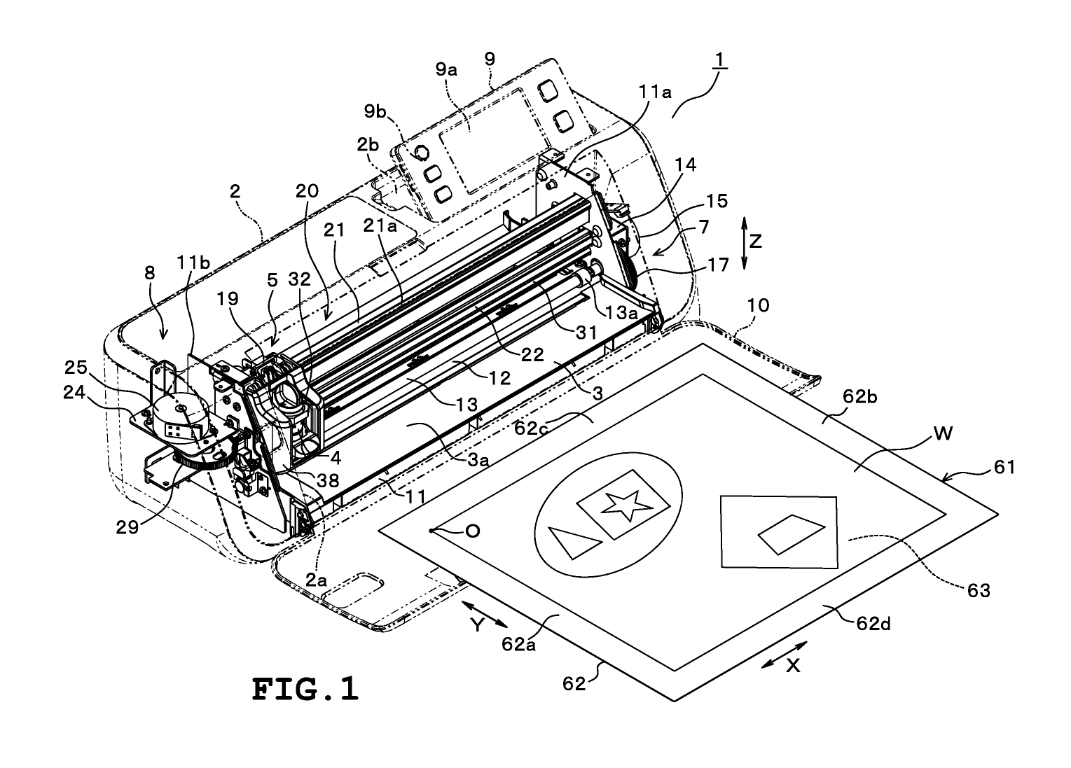

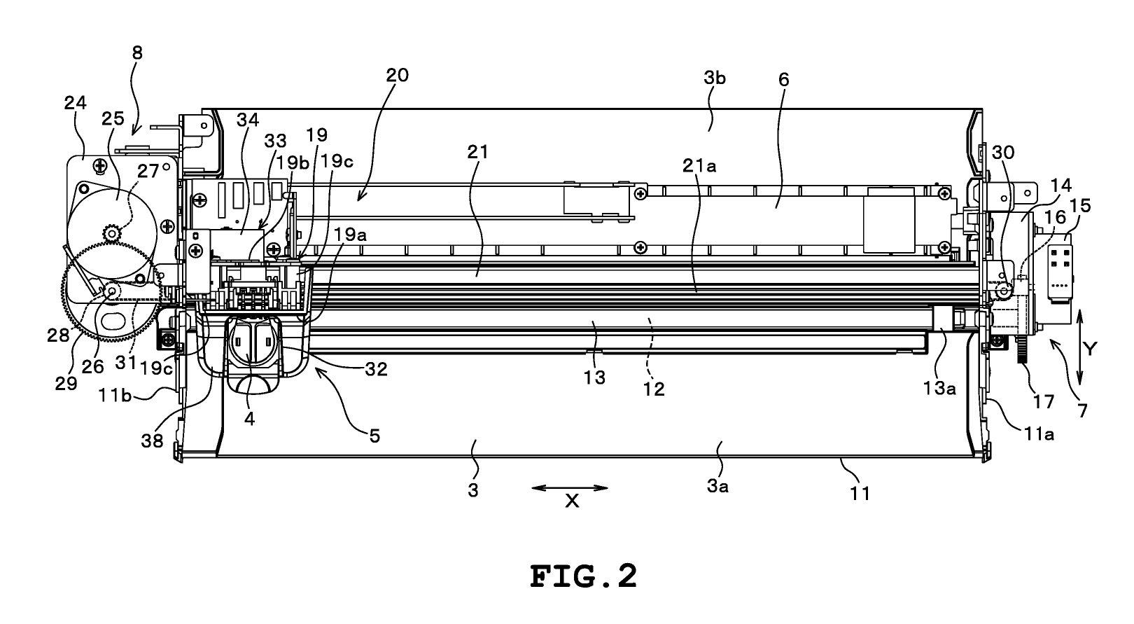

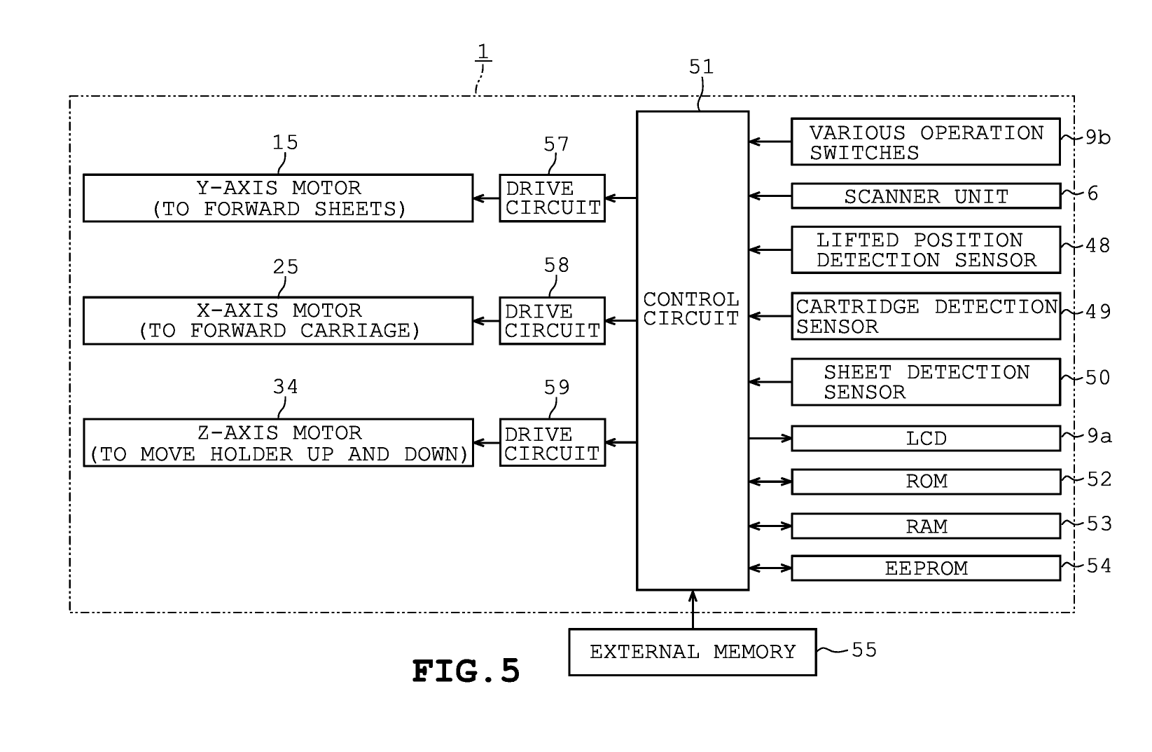

A first embodiment will be explained below, with reference to FIGS. 1 to 9. As illustrated in FIG. 1, a cutting apparatus 1 according to the present embodiment includes a body cover 2, a platen 3 provided within the body cover 2, and a cut head 5. The cut head 5 is configured to cut a sheet-like workpiece W such as paper, cloth, or the like and structures a part of a cutting mechanism 20. As described in detail later, the cut head 5 includes a carriage 19. The carriage 19 is provided with a cartridge holder 32 and an up-down drive mechanism 33. To the cartridge holder 32, a cutter cartridge 4 (see FIG. 4) having a cutter 44 is detachably attached. Further, the cutting apparatus 1 includes a scanner unit 6 (see FIGS. 2 and 5) configured to read a pattern from a surface of the sheet-like workpiece W and to generate image data.

The cutting apparatus 1 includes a holding member 61 configured to hold the workpiece W. The holding member 61 is configured by using a relatively soft synthetic resin material. The holding member 61 includes: a sheet-like base portion 62 that has a substantially square shape; and an adhesive portion 63 which is provided on the upper surface of the base portion 62 and on which the workpiece W is placed. The adhesive portion 63 is obtained by applying an adhesive agent to a rectangular region on the inside of the upper surface of the base portion 62, while excluding perimeter portions 62a and 62b on the left and the right as well as side portions 62c and 62d in the front and the rear. The adhesiveness force of the adhesive portion 63 is arranged in such a manner that the workpiece W is unmovably held during reading and cutting operations and that it is possible to peel the workpiece W relatively easily after these operations.

As illustrated in FIG. 1, the body cover 2 is in the shape of a rectangular box that is oblong in the left and right direction and of which the front face is slightly slanted downward. The front face portion of the body cover 2 has formed therein a front opening 2a extending in the left and right direction. Further, in a lower side portion of the front face of the body cover 2, a front cover 10 configured to open and close the front opening 2a is provided so as to be pivotally movable. As illustrated in FIG. 1, while the front cover 10 is open, the holding member 61 is inserted into the cutting apparatus 1 from the front, so as to be set on the platen 3.

An operation panel 9 is provided in a right side portion of the upper surface of the body cover 2. The operation panel 9 is structured as a rectangular panel that is oblong in the left and right direction. The operation panel 9 is provided, on the front face thereof, with a display 9a configured with a full-color liquid crystal display device and is also provided with various types of operation switches 9b used by a user to perform various types of instructing, selecting, and inputting operations. The various types of operation switches 9b include a touch panel provided on the surface of the display 9a. It is possible to change the position of the operation panel 9 between an out-of-use position where the operation panel 9 is housed in a recess portion 2b formed on the upper surface of the body cover 2 and an in-use position where the operation panel 9 is diagonally raised while the front face portion thereof is facing forward as illustrated in the drawing.

As illustrated also in FIG. 2, a machine frame 11 is provided on the inside of the body cover 2. The platen 3 is provided on the machine frame 11. As illustrated in FIG. 2, the platen 3 is configured with a front platen 3a and a rear platen 3b. The upper surface portion of the platen 3 is shaped as a horizontal plane. The platen 3 is subject to a feeding operation, while the holding member 61 holding the workpiece W is placed thereon. The machine frame 11 is provided with a right sidewall 11a and a left sidewall 11b that face each other while being positioned on the right and left sides of the platen 3, respectively.

The machine frame 11 disposed inside the body cover 2 is provided with a feed mechanism 7 that feeds the holding member 61 on the platen 3 in the front and back direction. Further, also provided is a cutter transfer mechanism 8 configured to transfer the cut head 5 (i.e., the carriage 19) along the left and right direction orthogonal to the feeding direction of the holding member 61. The cut head 5, the feed mechanism 7, the cutter transfer mechanism 8, and the like structure a cutting mechanism 20. Directions used in the present embodiment can be defined as follows: The feeding direction of the feed mechanism 7 will be referred to as a Y direction, which is the front and back direction; the transfer direction of the cutter transfer mechanism 8 will be referred to as an X direction, which is the left and right direction; and the direction orthogonal to the front and back direction and to the left and right direction will be referred to as a Z direction, which is the up and down direction.

Next, the feed mechanism 7 will be explained. As illustrated in FIGS. 1 and 2, between the right sidewall 11a and the left sidewall 11b, a drive roller 12 and a pinch roller shaft 13 each extending in the X direction are disposed in a gap part formed by the front platen 3a and the rear platen 3b, while one is disposed over the other in the up and down direction. The drive roller 12 is positioned so that the upper end thereof is substantially at the same height as the upper surface of the platen 3, while the two ends thereof are rotatably supported by the right and left sidewalls 11a and 11b. In addition to this configuration, as illustrated in FIG. 2, the right end of the drive roller 12 extends toward the right through the right sidewall 11a, so as to have a follower gear 17 having a large diameter fixed to the tip end thereof.

As illustrated in FIG. 2, a mount frame 14 is attached to the outer surface side of the right sidewall 11a. A Y-axis motor 15 configured by using a stepper motor, for example, is mounted on the mount frame 14. A drive gear 16 having a small diameter is fixed to the output shaft of the Y-axis motor 15, while the drive gear 16 meshes with the follower gear 17. In this configuration, as the Y-axis motor 15 turns in forward and reverse directions, the drive roller 12 is driven to rotate in forward and reverse directions.

The two ends of the pinch roller shaft 13 are rotatably supported by the right and left sidewalls 11a and 11b, in such a manner that the pinch roller shaft 13 is slightly movable in the up and down direction, i.e., the thickness direction of the workpiece W or the like. The pinch roller shaft 13 is urged at all times downward, i.e., toward the drive roller 12, by tension coil springs (not illustrated) each of which is provided on the outer surface side of a different one of the right and left sidewalls 11a and 11b. Further, as illustrated in FIGS. 1 and 2, the pinch roller shaft 13 is provided with roller portions 13a (only the one on the right side is illustrated) each having a slightly large diameter and being positioned in a location close to the ends on the left and the right.

Thus, the left and right perimeter portions 62a and 62b of the holding member 61 are each interposed and held between the drive roller 12 and the roller portions 13a of the pinch roller shaft 13. The feed mechanism 7 feeds the holding member 61 in the Y direction by a rotational drive of the drive roller 12 caused by the driving of the Y-axis motor 15, while the perimeter portions on the left and the right of the holding member 61 are being held between the drive roller 12 and the roller portions 13a of the pinch roller shaft 13. In the platen 3 part, a sheet detection sensor 50 (illustrated only in FIG. 5) is provided between the roller portions 13a of the pinch roller shaft 13 and the drive roller 12, the sheet detection sensor 50 being configured to detect that a front end portion of the holding member 61 is inserted from the front.

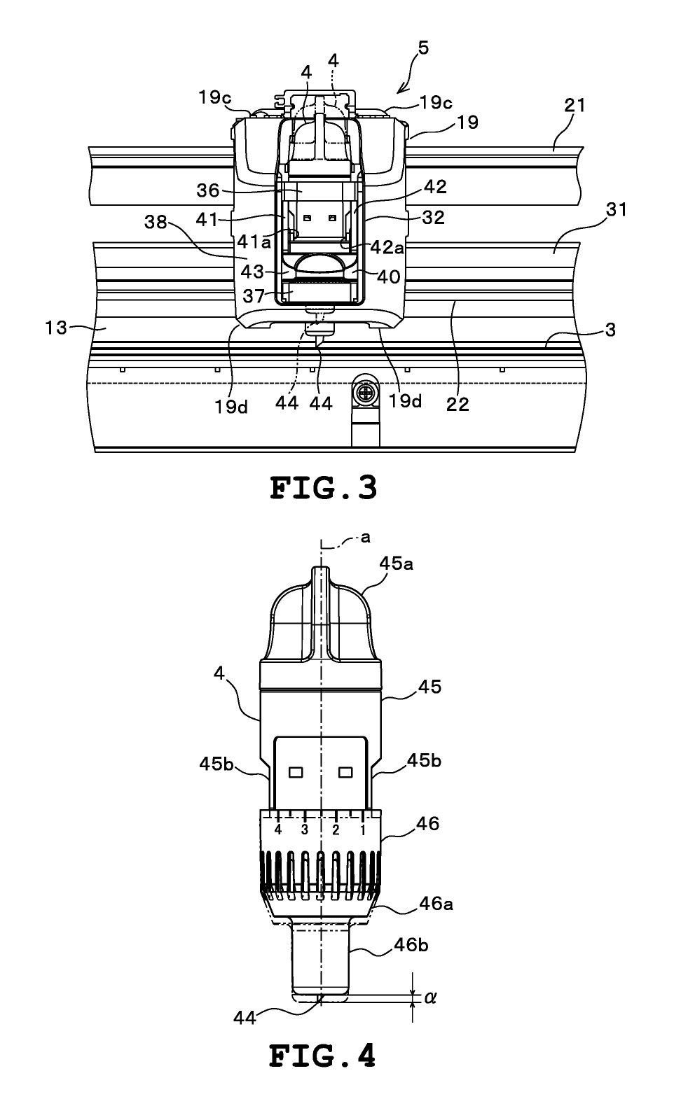

The cutter transfer mechanism 8 is configured to transfer the cut head 5, i.e., the carriage 19 along the X direction and is structured as follows: As illustrated in FIGS. 1 to 3, between the right and left sidewalls 11a and 11b, guide rails 21 and 22 are disposed so as to be positioned above and slightly behind the pinch roller shaft 13, while extending substantially parallel to the pinch roller shaft 13, i.e., along the X direction. As illustrated in FIG. 3, the guide rails 21 and 22 are arranged in such a manner that one is positioned over the other in the up and down direction.

As illustrated in FIG. 2, on the upper surface portion of the upper guide rail 21, an upper guide groove 21a is formed so as to extend over the whole length along the left and right direction. Although not shown in the drawings, also on the lower surface portion of the lower guide rail 22, a lower guide groove is formed so as to extend over the whole length along the left and right direction. Further, in the upper and the lower portions of the carriage 19, protrusions (not illustrated) are integrally formed so as to extend along the left and right direction, the protrusions each engaging with a corresponding one of the upper guide groove 21a and the lower guide groove. The carriage 19 is supported so as to be slidable along the X direction, as a result of each of the protrusions slidably engaging with the corresponding one of the upper guide groove 21a and the lower guide groove, while the protrusions from the upper side and from the lower side arrange the two guide rails 21 and 22 to be sandwiched therebetween.

As illustrated in FIGS. 1 and 2, to a position closer to the rear on the outer surface side of the left sidewall 11b, a mount frame 24 is fixed while extending horizontally. To the mount frame 24, which is positioned on the left side, an X-axis motor 25 is attached facing downward, while being positioned on the rear side. As illustrated in FIG. 2, to the output shaft of the X-axis motor 25, a drive gear 27 having a small diameter is fixed. The mount frame 24 has, on the front side thereof, a pulley shaft 26 that extends vertically. The pulley shaft 26 rotatably supports a follower gear 29 having a large diameter and meshing with the drive gear 27, as well as a timing pulley 28. The timing pulley 28 and the follower gear 29 rotate integrally with each other.

In contrast, as illustrated in FIG. 2, to the mount frame 14, which is positioned on the right side, a timing pulley 30 is rotatably provided in such a manner that the axis direction thereof corresponds to the up and down direction. An endless timing belt 31 spans horizontally between the timing pulley 30 and the timing pulley 28, while extending along the left and right direction. The intermediate portion of the timing belt 31 is connected to a mount portion (not illustrated) of the carriage 19. The cutter transfer mechanism 8 is structured in this manner. As the X-axis motor 25 generates the rotational drive, the force thereof is transmitted to the timing belt 31 via the follower gear 29 and the timing pulley 28, so as to transfer the carriage 19 (i.e., the cut head 5) along the left and right direction.

Next, configurations of the carriage 19, the cartridge holder 32, and the up-down drive mechanism 33 will be explained, with reference to FIGS. 3 and 4 also.

The carriage 19 has a front wall 19a, a rear wall 19b, left and right upper arms 19c, 19c that connect the walls 19a and 19b to each other on the upper side, and left and right lower arms 19d, 19d (see FIG. 3) that connect the walls 19a and 19b to each other on the lower side. As a result, the carriage 19 is in the shape of a rectangular box of which the left and right portions are open. The carriage 19 is shaped so as to surround the front, rear, upper, and lower sides of the guide rails 21 and 22. Although not illustrated, the above-mentioned protrusions are provided in the lower portions of the upper arms 19c, 19c and in the upper portions of the lower arms 19d, 19d, so that the carriage 19 is slidable in the X direction along the guide rails 21 and 22.

Although not illustrated, between the upper arm 19c and the lower arm 19d on the left side and between the upper arm 19c and the lower arm 19d on the right side, shafts are attached so as to each extend in the up and down direction. The cartridge holder 32 is supported by the shafts so as to be movable in the up and down indirection. To the rear wall 19b of the carriage 19, a Z-axis motor 34 (see FIG. 2) is mounted so as to face forward. Further, although not illustrated in detail, provided between the Z-axis motor 34 and the cartridge holder 32 are a gear mechanism that decelerates the rotation of the Z-axis motor 34 and a rack-and-pinion mechanism that converts the rotation of the gear mechanism into the up and down movement of the cartridge holder 32. The up-down drive mechanism 33 is structured in this manner.

In this configuration, due to the operation of the up-down drive mechanism 33, when the Z-axis motor 34 is rotated in the forward direction, the cartridge holder 32 is lowered. On the contrary, when the Z-axis motor 34 is rotated in the reverse direction, the cartridge holder 32 is lifted. In these situations, the cartridge holder 32 is moved between a lowered position (illustrated with the solid line in FIG. 3) where a cutting process is performed on the workpiece W to be cut by the cutter 44 (described later) and a lifted position (illustrated with the double-dot chain line in FIG. 3) where the blade tip of the cutter 44 is upwardly spaced apart from the workpiece W by a predetermined distance. Although not illustrated in detail in the drawings, the carriage 19 is provided with a lifted position detection sensor 48 (see FIG. 5) configured to detect that the cartridge holder 32 is in the lifted position. Further, the carriage 19 is also provided with a cartridge detection sensor 49 (see FIG. 5) configured to detect that the cutter cartridge 4 is attached to the cartridge holder 32.

Next, a configuration of the cartridge holder 32 will be explained. As illustrated in FIG. 3 and so on, the cartridge holder 32 is shaped like a frame of which the front face is open and of which the dimension is suitable for being disposed between the left and right shafts of the carriage 19. The front wall 19a of the carriage 19 is provided with a cover member 38 configured to cover the left and right sides on the front thereof. The cartridge holder 32 is positioned in a central portion of the cover member 38, so as to be able to move along the up and down direction. As illustrated in FIG. 3, within the cartridge holder 32, an upper holder 36 and a lower holder 37 are installed, while each having a circular hole into which the cartridge 4 is inserted from above.

As illustrated in FIG. 3, the cartridge holder 32 is provided with a lever member 40 configured to lock and unlock the cutter cartridge 4. The lever member 40 includes a pair of arms 41 and 42 positioned on the left and on the right as well as an operating portion 43 provided so as to connect the tips of the arms 41 and 42 to each other. The base ends of the arms 41 and 42 are pivotally supported by the left and right sidewalls of the cartridge holder 32. Although not illustrated, the lever member 40 is configured so as to be able to rotate between an unlocked position in which the operating portion 43 is positioned above and a locked position as illustrated in FIG. 3 in which the operating portion 43 is positioned underneath.

In the inner surface portions of the left and right arms and 42 of the lever member 40, engagement projection portions 41a and 42a used for securing the cutter cartridge 4 are provided, respectively. When the lever member 40 is in the unlocked position, because the engagement projection portions 41a and 42a are positioned away from the cutter cartridge 4 in the forward direction and are therefore out of contact therewith, the user is able to perform operations of attaching and removing the cutter cartridge 4. In contrast, when the lever member 40 is in the locked position, because the engagement projection portions 41a and 42a are in contact with an outer circumferential portion of the cutter cartridge 4 so as to press the cutter cartridge 4 downward, the cutter cartridge 4 is secured on the cartridge holder 32.

Next, the cutter cartridge 4 will be explained, with reference to FIG. 4 also. The cutter cartridge 4 includes the cutter 44 configured with a cutting blade and a case body that has a substantially cylindrical shape and is configured to hold and house therein the cutter 44. Although not illustrated in detail, the cutter 44 includes a cutter shaft shaped like a round bar extending in the up and down direction and a blade tip portion formed in a lower end portion of the cutter shaft. The cutter shaft is supported by a bearing (not illustrated) provided in the case body 45 so as to be rotatable about a central axis “a”. The blade tip portion is shaped like the letter V which is slanted with respect to the workpiece W.

The case body 45 is shaped like a cylinder extending in the up and down direction. The case body 45 has a grip portion 45a provided in an upper end portion thereof. Further, on each of the left and right sides of a location close to the lower portion of the case body 45, a recess portion 45b is formed to avoid the engagement projection portions 41a and 42a. In the lower end portion of the case body 45, a cap portion 46 is attached. The upper half of the cap portion 46 is shaped like a cylinder that can be fitted into the outer circumference of the bottom portion of the case body 45. The lower half of the cap portion 46 has a small-diameter portion 46b that is structurally integral, via a tapered portion 46a. The engagement projection portions 41a and 42a of the lever member 40 engage with the upper end of the cap portion 46 and press the cutter cartridge 4 downward. The tapered portion 46a corresponds to the shape of the inner surface of the circular hole formed in the lower holder 37 of the cartridge holder 32. The small-diameter portion 46b is shaped to have a bottom face. Although not illustrated, the small-diameter portion 46b has formed therein, in a central portion thereof, a hole through which the blade tip portion of the cutter 44 is inserted.

Further, although not illustrated in detail, a male thread portion is formed on the outer circumferential surface of the bottom portion of the case body 45, whereas a female thread portion that is screwed together with the male thread portion is formed on the inner circumferential surface of the top portion of the cap portion 46. In other words, the case body 45 and the cap portion 46 are coupled together by the male thread portion and the female thread portion. With this configuration, it is possible to adjust the position of the cap portion 46 in the up and down direction, with respect to the case body 45. More specifically, it is possible to adjust the protrusion dimension “α” of the blade tip portion from the hole formed in the lower surface of the small-diameter portion 46b, by rotating the cap portion 46 with respect to the case body 45 as appropriate, in accordance with the thickness and the type of the workpiece W to be cut. In addition, on the outer circumferential surface of the cap portion 46, graduation marks used for adjusting the protrusion dimension “α” is provided.

In the configuration described above, in the state where the lever member 40 of the cartridge holder 32 has been rotated to the unlocked position above, the engagement projection portions 41a and 42a do not interfere with the cutter cartridge 4. Accordingly, the user is able to hold the grip portion 45a so as to take out the cutter cartridge 4 upward and remove the cutter cartridge 4 from the cartridge holder 32 and is also able to insert the cutter cartridge 4 into the cartridge holder 32 from above. After the cutter cartridge 4 has been inserted, when the user has performed the operation of rotating the lever member 40 to the locked position underneath, the engagement projection portions 41a and 42a engage with the upper end of the cap portion 46 and press the cutter cartridge 4 downward. As a result, the tapered portion 46a is fixed so as to be in close contact with the inner surface of the lower holder 37 of the cartridge holder 32. In this manner, the user is able to attach and detach the cutter cartridge 4 to and from the cartridge holder 32.

The cartridge holder 32 to which the cutter cartridge 4 has been attached in the manner described above is placed in the lifted position at normal times, i.e., when no cutting operation is being performed. In contrast, during a cutting operation, the cartridge holder 32 is moved to the lowered position by the up-down drive mechanism 33. In that state, the blade tip portion of the cutter 44 is in pressure contact with the workpiece W placed on the holding member 61 and is thus in the state of penetrating through the workpiece W. In that state, a cutting operation is performed on the workpiece W, by moving the cut head 5 (i.e., the cutter 44) along the X direction with the use of the cutter transfer mechanism 8, while moving the workpiece W held by the holding member 61 along the Y direction with the use of the feed mechanism 7. When the cutting operation is finished, the holding member 61 (the workpiece W) is ejected forward from the front face of the cutting apparatus 1 by the feed mechanism 7.

Further, as illustrated in FIG. 2, the cutting apparatus 1 according to the present embodiment is provided with the scanner unit 6 configured to read patterns from the surface of the workpiece W held by the holding member 61. The scanner unit 6 is configured by using a Contact Imaging Sensor (CIS), for example. Although not illustrated in detail, the scanner unit 6 is structured so as to include a line sensor configured by using a plurality of image pickup elements arranged along the X direction, a light source such as a lamp, a lens, and a sheet of contact glass all of which are structurally integral. The scanner unit 6 is positioned behind the guide rail 21 and is provided so as to extend along the X direction while having a length substantially equal to the width of the holding member 61. The scanner unit 6 is disposed in such a manner that the sheet of contact glass faces downward and that a surface of the workpiece W held by the holding member 61 is able to pass through a position near the sheet of contact glass.

The scanner unit 6 is configured to read the patterns from the surface of the workpiece W, while the feed mechanism is moving the holding member 61 rearward. In that situation, the scanner unit 6 and the feed mechanism 7 are controlled by a control circuit 51 (see FIG. 5). The control circuit 51 is configured to generate image data of the patterns read from the surface of the workpiece W by the scanner unit 6. Thus, the scanner unit 6, the control circuit 51, and the like structure an image data generating unit. The generated image data is used for generating the cut data, for example.

Next, a configuration of a control system of the cutting apparatus 1 will be explained, with reference to FIG. 5. The control circuit 51 serving as a controlling unit that exercises overall control of the cutting apparatus 1 is primarily configured with a computer (CPU) and has connected thereto a ROM 52, a RAM 53, and an EEPROM 54. In addition, it is possible to connect an external memory 55 such as a USB memory, for example, to the control circuit 51. The ROM 52 stores therein various types of control programs, such as a cut control program for controlling cutting operations, an image reading program for reading the image data, a cut data generating program for generating and editing the cut data, a display control program for controlling displays of the display 9a, and the like. The RAM 53 temporarily stores therein data and programs that are necessary to perform various types of processes. Either the EEPROM 54 or the external memory 55 stores therein the cut data used for cutting the patterns each having a predetermined shape. In particular, as explained in detail later, the EEPROM 54 functions as a storage unit configured to store the generated cut data therein.

The control circuit 51 is configured to receive inputs of a read signal from the scanner unit 6, an operation signal from the various types of operation switches 9b, a signal from the lifted position detection sensor 48, a signal from the cartridge detection sensor 49, and a signal from the sheet detection sensor 50.

The cut data includes a set of data of coordinate values indicating coordinates that are defined in the X-Y coordinate system of the cutting apparatus 1 and that represent vertices of cut lines that are a plurality of line segments. For this reason, the larger the number of line segments is, the larger is the quantity of sets of coordinate values representing the vertices, and therefore, the larger is the volume of the cut data. The origin O of the X-Y coordinate system is, as illustrated in FIG. 1, arranged to be on the left front corner of the adhesive portion 63 of the holding member 61.

Further, as illustrated in FIG. 5, the control circuit 51 has the display 9a connected thereto. On a screen of the display 9a, a mode selecting screen, a pattern selecting screen, a positional arrangement display screen, and/or the like are displayed. By operating the various types of operation switches 9b while looking at what is displayed on the display 9a, the user is able to select an operation mode, to select a desired pattern, and to set a cut position.

Further, as illustrated in FIG. 5, the control circuit 51 has connected thereto drive circuits 57, 58, and 59, each of which drives a corresponding one of the Y-axis motor 15, the X-axis motor 25, and the Z-axis motor 34. By executing the cut control program, the control circuit 51 automatically causes a cutting operation or the like to be executed on the workpiece W placed on the holding member 61, by controlling the Y-axis motor 15, the X-axis motor 25, and the Z-axis motor 34, on the basis of the cut line data. Accordingly, the control circuit 51 is able to have the workpiece W cut along the contour lines of the patterns, by moving the cut head 5 (which means moving the cutter 44 also) along the X direction with the use of the cutter transfer mechanism 8, while moving the holding member 61 holding the workpiece W along the Y direction with the use of the feed mechanism 7.

Further, when causing the scanner unit 6 to execute the reading operation, the control circuit 51 obtains a read image, which is an image of the patterns on the surface of the workpiece W, by moving the holding member 61 holding the workpiece W along the Y direction toward the rear side of the platen 3 with the use of the feed mechanism 7, while causing the scanner unit 6 to perform the reading operation in synchronization with the moving of the holding member 61. The control circuit 51 generates the image data of the patterns on the surface of the workpiece W by performing a well-known image processing process such as a binarization process on the obtained read image. It is assumed that a “pattern” is expressed with a single endless enclosing line (which may be a straight, curved, and/or inflected line) and may be a contour of a shape, for example.

In the present embodiment, as explained later in the description of operations (with reference to the flowcharts), the control circuit 51 functions as a cut data generating unit configured to generate cut data from the image data generated on the basis of the reading process performed by the scanner unit 6, by using a software configuration, i.e., by executing the cut data generating program. In this situation, the cut data generating program does not necessarily have to be stored in the ROM 52 in advance, but may be recorded on an external recording medium (not illustrated) such as an optical disk or the like, for example, so as to be read from the recording medium. Alternatively, the cut data generating program may be downloaded from an external server via a network.

In this situation, in the present embodiment, when the cut data has been generated from the image data, the control circuit 51 is configured to judge whether or not the volume of the generated cut data exceeds a predetermined threshold value. In the present embodiment, the predetermined threshold value is a value indicating an upper limit for the volume of data which the control circuit 51 is capable of processing at a time. The predetermined threshold value is stored in the ROM 52 in advance. Further, when the volume of the cut data exceeds the threshold value, the cut data is divided into a plurality of divided sections of cut data each having a volume equal to or smaller than the threshold value. Further, the plurality of divided sections of cut data are stored, section by section, into the EEPROM 54. Accordingly, the control circuit 51 also functions as a judging unit, a dividing unit, and a storage controlling unit. After that, the control circuit 51 sequentially loads the plurality of divided sections of cut data stored in the EEPROM 54, into the RAM 53, so as to execute the cutting process. The predetermined threshold value explained above may be 1 megabyte, for example, but is not limited to this numerical value.

In this situation, in the present embodiment, when dividing the cut data into the plurality of divided sections of cut data, the control circuit 51 is configured to separate the patterns expressed in the cut data into a plurality of regions and to further divide the cut data into the divided sections in correspondence with the plurality of regions. Further, when separating the patterns into the plurality of regions in this manner, the control circuit 51 is configured to separate the patterns in such a manner that one of the regions is included in another one of the regions. The control circuit 51 is also configured to set a cutting order in which the cutting mechanism 20 is to cut the pattern positioned in the one of the regions and the pattern positioned in the other region and is configured to divide the cut data according to the cutting order. Consequently, the control circuit 51 further functions also as a region separating unit and a setting unit. The EEPROM 54 stores therein a plurality of data tables. In each of the data tables, numbers are assigned in correspondence with the cutting order. In each of the data tables, the divided sections of cut data kept in correspondence with the cutting order are stored.

In the present embodiment, when setting the cutting order as described above, the control circuit 51 appends a piece of label information to each of the patterns, the pieces of label information indicating the order by which the patterns are to be cut by the cutting mechanism 20, in accordance with inclusion relationships among the plurality of regions. In this situation, the pieces of label information are appended to the patterns so as to indicate the cutting order by which such a pattern that is positioned in an inside region having the inclusion relationship is to be cut first. More specifically, at an initial stage, the control circuit 51 uses the entire area of the cut data as a searched region, extracts a pattern that is defined by an enclosing line and is positioned outermost within the searched region, and further appends a first piece of label information to the extracted pattern. At the following stage, the control circuit 51 uses the inside of the pattern to which the first piece of label information was appended as a next searched area, extracts a pattern that is defined by an enclosing line and is positioned outermost within the searched region, and further appends a second piece of label information to the extracted pattern. The control circuit 51 repeatedly performs the search process and the label information appending process described above on each of all the patterns. For example, the pieces of label information may be integers starting with 1. In other words, the first piece of label information is (1), the second piece of label information is (2), a third piece of label information is (3), and so on. After that, the control circuit 51 sets the cutting order of the patterns as the descending order of the numerical values of the pieces of label information.

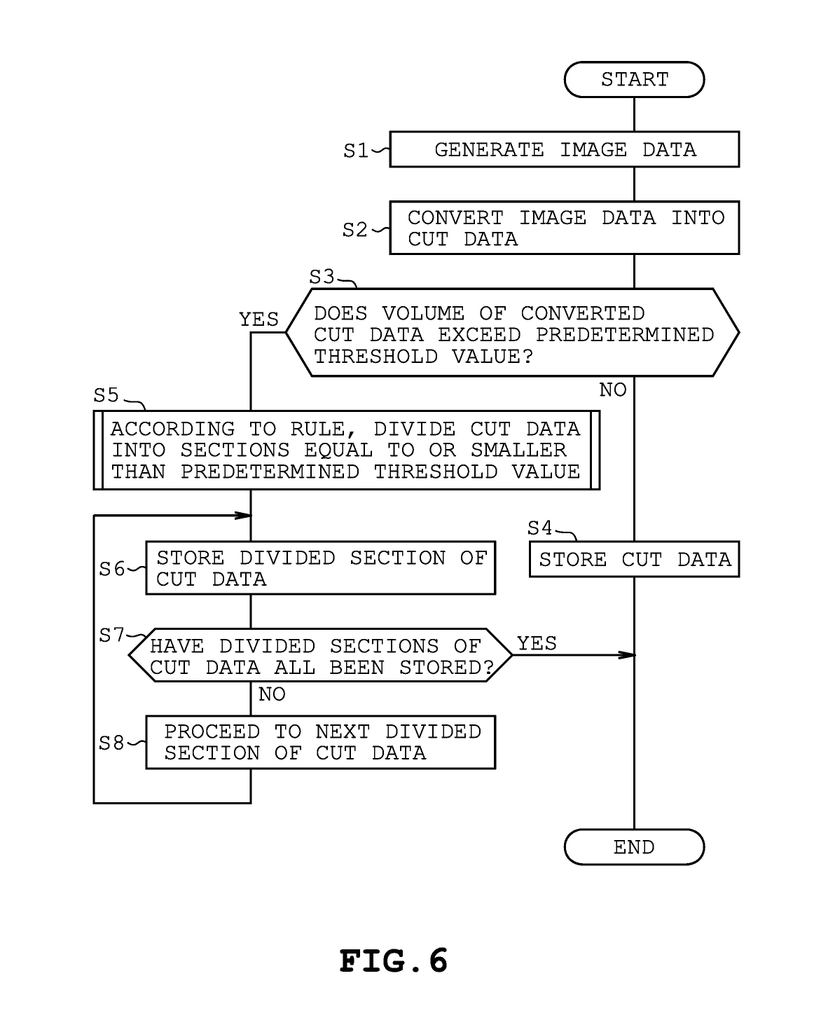

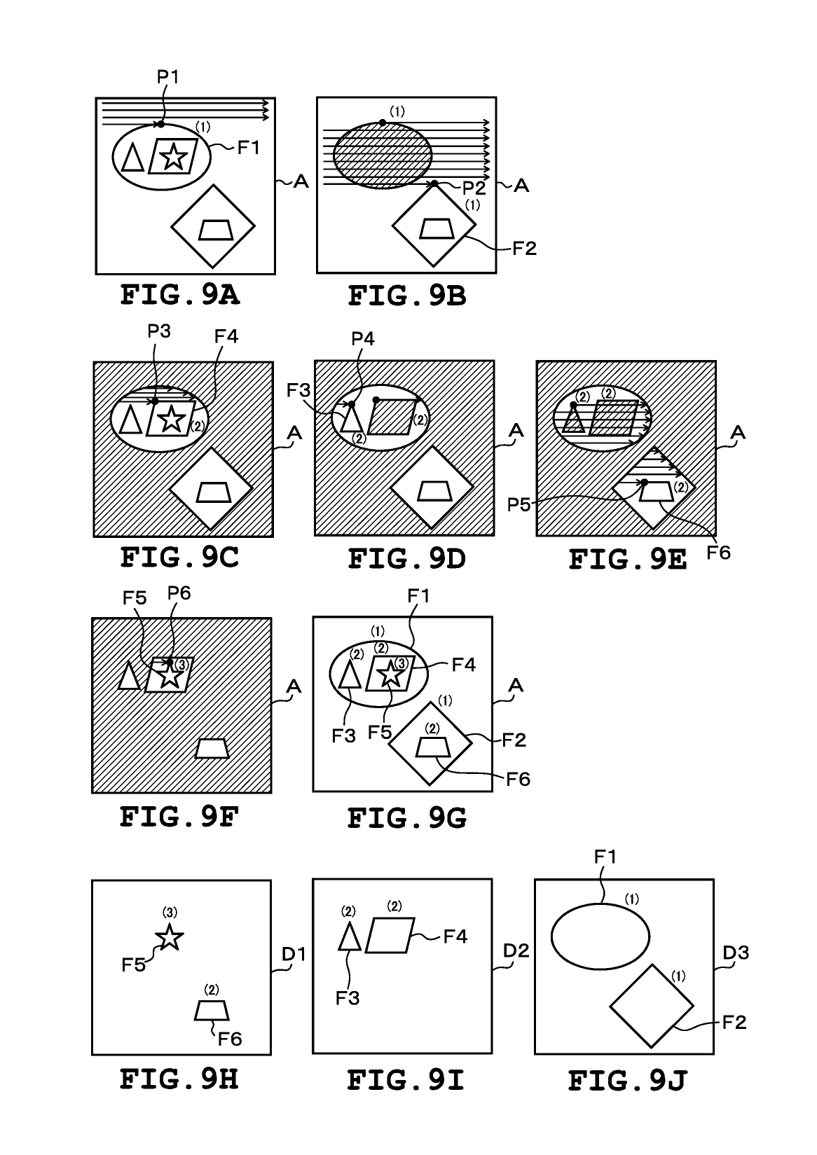

Next, an operation performed in the configuration described above will be explained, with reference to FIGS. 6 to 9 also. In the present description, a specific example will be explained in which, patterns F1 to F6 formed on the surface of the workpiece W are expressed in the cut data, as illustrated in FIGS. 9A, 9G, and so on. In other words, within a substantially square area A in which the cut data is present, a large oval pattern F1 slightly oblong in the left and right direction is positioned in the upper left section, while a slightly large diamond pattern F2 is positioned in the lower right section. On the inside of the oval pattern F1, a triangular pattern F3 is positioned on the left side, while a parallelogrammatic pattern F4 is positioned on the right side. Further, on the inside of the parallelogrammatic pattern F4, a star-shaped pattern F5 is positioned. On the inside of the diamond pattern F2, a trapezoidal pattern F6 is positioned.

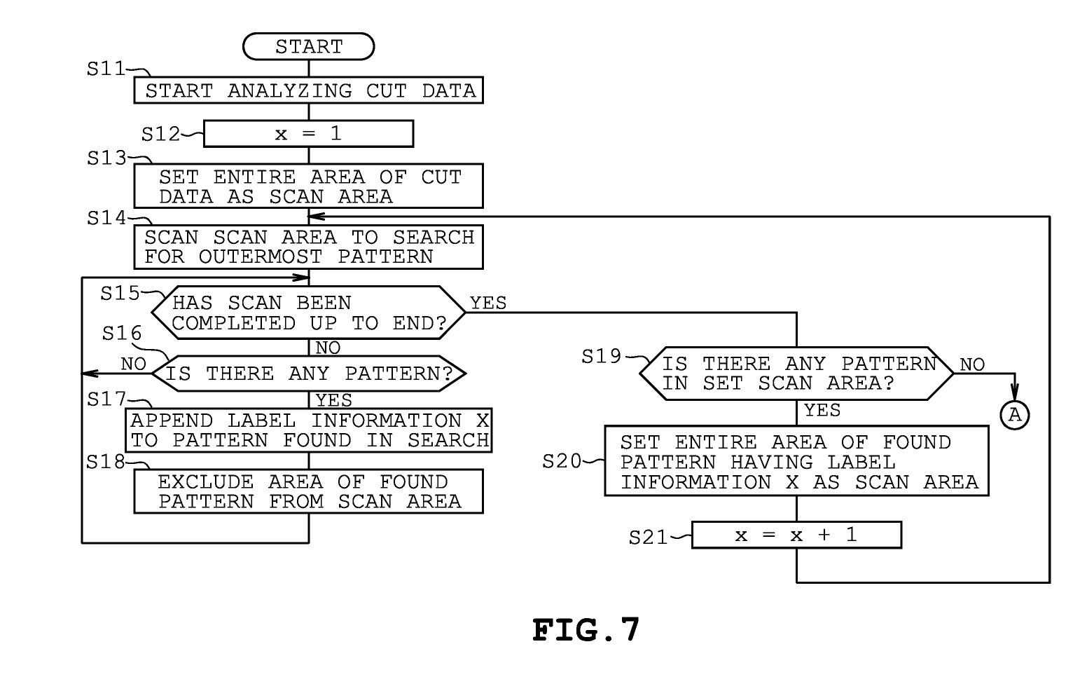

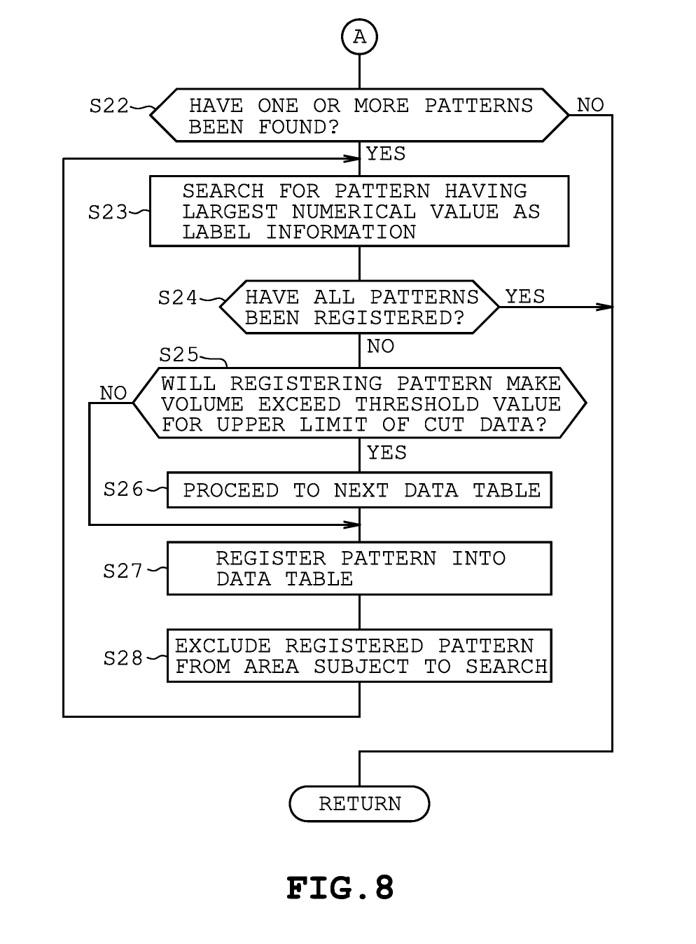

The flowchart in FIG. 6 illustrates a procedure in a main process performed by the control circuit 51, i.e., an overall process including the cut data dividing process and the cut data divided section storing process. Further, the flowcharts in FIGS. 7 and 8 illustrate a detailed procedure in the cut data dividing process (step S5) in FIG. 6. Although the flowcharts shown in FIGS. 7 and 8 are supposed to form a single continuous flowchart, the procedure is shown in the two separate drawings, for a reason related to the space in each of the drawing pages.

As illustrated in FIG. 6, at step S1, image data is generated as a result of the reading operation performed by the scanner unit 6 from the surface of the workpiece W. At step S2, a process is performed to convert the image data into the cut data. The processes at steps S1 and S2 may be performed by implementing any of well-known methods, and detailed explanations thereof will be omitted. At step S3, it is judged whether or not the volume of the cut data resulting from the conversion exceeds a predetermined threshold value. When the volume of the cut data is equal to or smaller than the threshold value (step S3: No), the cut data is stored into the EEPROM 54 at step S4, and the process is ended.

On the contrary, when the volume of the cut data exceeds the threshold value (step S3: Yes), a process is performed at step S5 to divide, according to a predetermined rule, the cut data into a plurality of divided sections of cut data each having a volume equal to or smaller than the predetermined threshold values. Detailed procedure in the process at step S5 will be explained with reference to the flowcharts in FIGS. 7 and 8. When the cut data dividing process is finished, the divided sections of cut data are stored into the EEPROM 54 at step S6.

At step S7, it is judged whether or not the storing of all the divided sections of cut data has been completed. When the storing of all the divided sections of cut data has not been completed (step S7: No), the process proceeds to the next divided section of cut data at step S8. Subsequently, the divided section of cut data is stored at step S6. In this manner, when the storing of all the divided sections of cut data has been completed (step S7: Yes), the process is ended. In the manner described above, the plurality of divided sections of cut data are stored, section by section, into the EEPROM 54.

Next, the cut data dividing process according to the present embodiment, i.e., details of the process at step S5 in FIG. 6, will be explained, with reference to FIGS. 7 to 9. In FIG. 7, at step S11, a cut data analyzing processing is started. At step S12, label information X is set to 1. At step S13, the entire area of the cut data is set as a scan area, i.e., a searched region. At step S14, the inside of the scan area is scanned, so as to search for a pattern that is formed by an enclosed line and is positioned outermost. At step S15, it is judged whether or not the scan has been completed up to the terminal end of the scan area. When the scan has not been completed up to the terminal end (step S15: No), it is judged, at step S16, whether or not there is any pattern.

As illustrated in FIG. 9A, the entire area of the cut data corresponds to the inside of the area A that is substantially square. The inside of the area A serves as the scan area. The scan is performed from the left to the right, while using the top left corner as a starting point, for example. The scan sequentially progresses downward. The manner in which the scan is performed is schematically illustrated with the arrows. In this situation, as illustrated in FIG. 9A, the scanning arrow meets the oval pattern F1 at the point P1. The pattern F1 is found to be formed by an enclosed line that starts at the point P1, extends in one direction along the outline of the pattern F1, and returns to the point P1 after making the round. Thus, the first pattern F1 is extracted. Returning to the description of FIG. 7, when a pattern has been extracted, i.e., when there is at least one pattern (step S16: Yes), the label information X is appended to the found pattern at step S17. In that situation, because this is the first scan, the piece of label information appended to the pattern F1 is (1). At step S18, the area inside the found pattern is excluded from the scan area, and the processes from step S15 are repeatedly performed.

In FIG. 9B, the area inside the pattern F1 excluded from the scan area is indicated with hatching, for the sake of convenience. In that situation, because the scan has not been completed up to the terminal end of the scan area (step S15: No), the scan continues to be performed. Subsequently, as illustrated in FIG. 9B, the scanning arrow meets the diamond pattern F2 at the point P2, and the pattern F2 is thus extracted (step S16: Yes). In this situation, a piece of label information (1) is also appended to the pattern F2 at step S17. At step S18, the area inside the pattern F2 is excluded from the scan area. Subsequently, after the pattern F2 has been found, the scan is performed up to the terminal end.

In FIG. 7, when the scan has been completed up to the terminal end of the scan area (step S15: Yes), it is judged, at step S19, whether or not there is any pattern in the set scan area. When there is at least one pattern (step S19: Yes), the entire area on the inside of the found pattern having the label information X is set as a next scan area, at step S20. After that, at step S21, the numerical value of the label information X is incremented by one, so that the processes from step S14 are repeatedly performed.

As a result, as illustrated in FIG. 9C, the areas other than the parts shown with the hatching, i.e., the inside of the pattern F1 and the inside of the pattern F2 are set as the next scan areas, so that a scan is sequentially performed from the top. In that situation, first, the pattern F4 is extracted at the point P3, and a piece of label information (2) is appended to the pattern F4. Subsequently, as illustrated in FIG. 9D, a scan is performed while the area inside the pattern F4 is excluded from the scan area. The pattern F3 is extracted at the point P4, and a piece of label information (2) is appended to the pattern F3. After that, as illustrated in FIG. 9E, a scan is further performed while the pattern F3 is excluded from the scan area. The pattern F6 is extracted at the point P5, and a piece of label information (2) is appended to the pattern F6.

After that, the judgment result at step S19 is “Yes” again. At step S20, the areas inside the found patterns F4, F3, and F6 each having the piece of label information (2) are set as scan areas (see FIG. 9F). At step S21, the label information X is incremented so as to become 3, and the processes from step S14 are repeatedly performed. As illustrated in FIG. 9F, a scan is performed by setting scan areas in the three locations, namely the patterns F4, F3, and F6. In that situation, within the pattern F4, the pattern F5 is extracted at the point P6, and a piece of label information (3) is appended to the pattern F5. After that, at step S20, a scan is performed by setting the inside of the pattern F5 having the piece of label information (3) as a scan area. However, because there is no pattern on the inside of the pattern F5, the judgment result at step S19 in FIG. 17 is “No”, and the process thus proceeds to step S22 in FIG. 8.

At step S22, it is judged whether or not at least one pattern was found in the processes at steps S11 through S21. When no pattern was found (step S22: No), the process is ended then. When at least one pattern was found (step S22: Yes), the pattern having the largest numerical value as the label information is searched for from among the patterns at step S23. As illustrated in FIG. 9G, the piece of label information appended to each of the patterns F1 and F2 is (1), while the piece of label information appended to each of the patterns F3, F4, and F6 is (2), and the piece of label information appended to the pattern F5 is (3). Accordingly, when the process at step S23 is performed for the first time, the pattern F5 having the piece of label information (3) is found in the search.

As illustrated in FIG. 8, at step S24 that follows, it is judged whether or not the registration of all the patterns into the data table provided in the EEPROM 54 has been completed. When the registration of all the patterns has not been completed yet (step S24: No), it is judged, at step S25, whether or not registering the not-yet-registered pattern into the data table will make the volume of the cut data stored in the data table exceed the threshold value (1 megabyte). When the volume will not exceed the threshold value (step S25: No), the process directly proceeds to step S27, the not-yet-registered pattern is registered into the data table. When the volume will exceed the threshold value (step S25: Yes), the process will proceed to the next data table at step S26. The pattern is registered into the data table at step S27. At step S28 that follows, the registered pattern is excluded from the area subject to the search, so that the processes from step S23 are repeatedly performed.

As illustrated in FIG. 9H, at first, the pattern F5 having the piece of label information (3) is registered into the first data table D1. Subsequently, from among the patterns each having a piece of label information (2), the pattern F6 is found in a search and is registered into the data table D1. In this situation, when there are two or more patterns having mutually the same piece of label information, the search (the registration) is performed in the order opposite to the order in which the patterns were found, for example. Subsequent to the pattern F6, the pattern F3 is found in the search. Let us assume that registering the pattern F3 into the data table D1 will make the volume of the cut data exceed the threshold value. In that situation, the pattern F3 is registered into the next data table D2, as illustrated in FIG. 9I. As a result, the patterns F3 and F4 are registered in the data table D2. Further, as illustrated in FIG. 9J, the patterns F2 and F1 are registered into the next data table D3.

When the registration of all the patterns has been completed in the manner described above (step S24: Yes), the data dividing process is ended. After that, the process proceeds to step S6 where each of the divided sections of cut data of the patterns F1 to F6 is stored into a corresponding one of the data tables D1 to D3 where the patterns F1 to F6 have been registered. In this manner, the divided sections of cut data each having a volume equal to or smaller than the threshold value are stored in the EEPROM 54. Further, when the cutting operations are to be performed on the workpiece W, the divided sections of cut data stored in the data tables D1 to D3 are sequentially read, so that the cutting operations are sequentially performed on the basis of the read divided sections of cut data. In this manner, even when the cut data has a large volume as a whole, it is possible to store the cut data into the EEPROM 54 in the form of the plurality of divided sections of cut data. Further, on the basis of the plurality of divided sections of cut data, it is possible to cut the patterns F1 to F6 all at once.

In this situation, when the cutting apparatus 1 cuts (cuts out) the patterns having an inclusion relationship from the workpiece W, it is desirable to cut the pattern positioned on the inside first, before cutting the pattern positioned on the outside. The reason can be explained as follows: Because the workpiece W is held by the holding member 61 with the adhesive force of the adhesive portion 63, cutting each pattern while the workpiece W is adhered in a larger area prevents the workpiece W from shifting out of place and makes it possible to cut the patterns with an excellent level of precision.

In the present embodiment, the cutting operations are performed by sequentially reading the divided sections of cut data stored in the data tables D1 to D3. The order in which the divided sections of cut data are read is the same as the order in which the patterns were registered. In other words, the divided sections of cut data are read in the order of: the pattern F5, the pattern F6, the pattern F3, the pattern F4, the pattern F2, and the pattern F1. Accordingly, with respect to the patterns F1 to F6 having the inclusion relationships, the cutting apparatus 1 is able to cut the patterns positioned on the inside first, before cutting the patterns positioned on the outside. In other words, in the present embodiment, the cutting order is set in such a manner that the patterns are separated in such a manner that one of the regions is included in another one of the regions, so that such a pattern that is positioned in an inside region having the inclusion relationship is to be cut first. With these arrangements, the cutting apparatus 1 is able to cut the patterns from the workpiece W with an excellent level of precision.

As explained above, according to the present embodiment, an advantageous effect is achieved where, even when the volume of the cut data generated on the basis of the image data of the patterns read by the scanner unit 6 exceeds the predetermined level, it is possible to store the cut data into the EEPROM 54 serving as a storage unit, in the form of the divided sections of cut data each having a volume processable by the cutting apparatus 1. Further, according to the present embodiment, when the cut data is divided into the divided sections of cut data, it is possible to set the cutting order appropriately. In other words, according to the embodiment, with respect to the patterns having the inclusion relationships, it is possible to efficiently perform the cutting order setting process by appending the pieces of label information indicating the cutting order to the patterns.

### (2) Second Embodiment and Other Embodiments

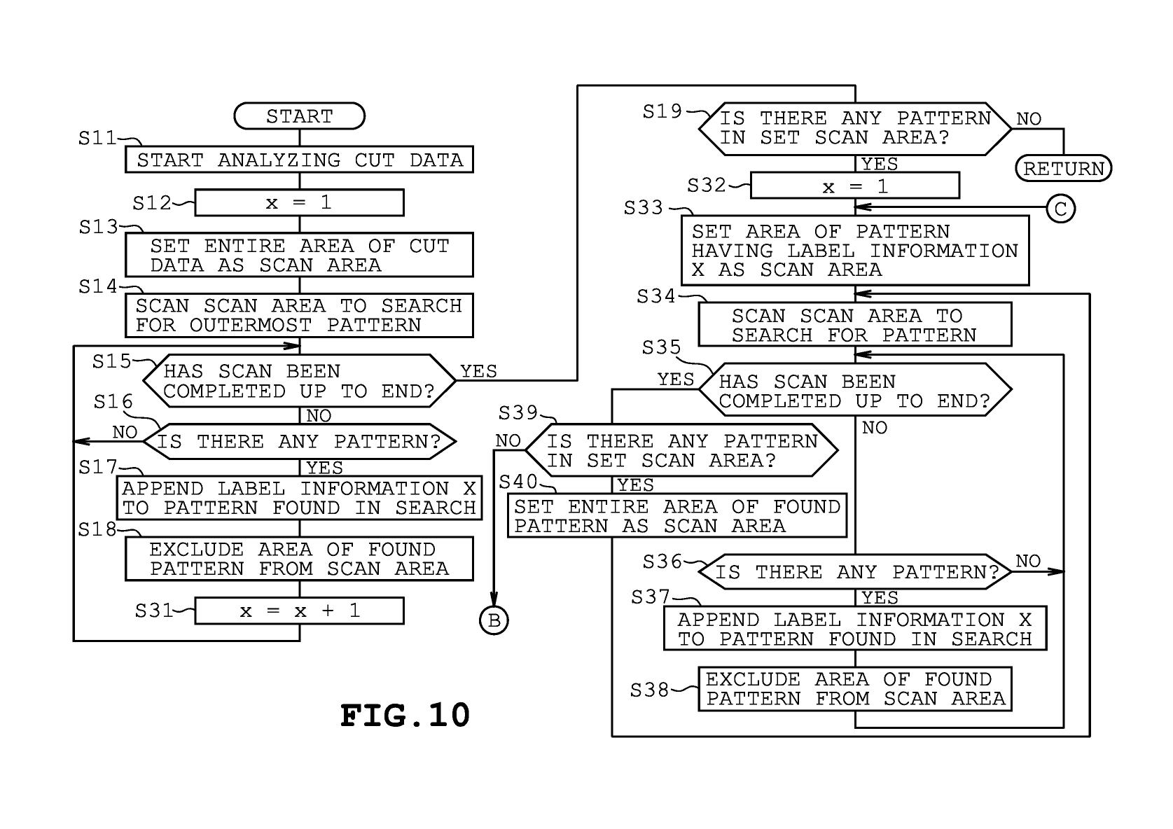

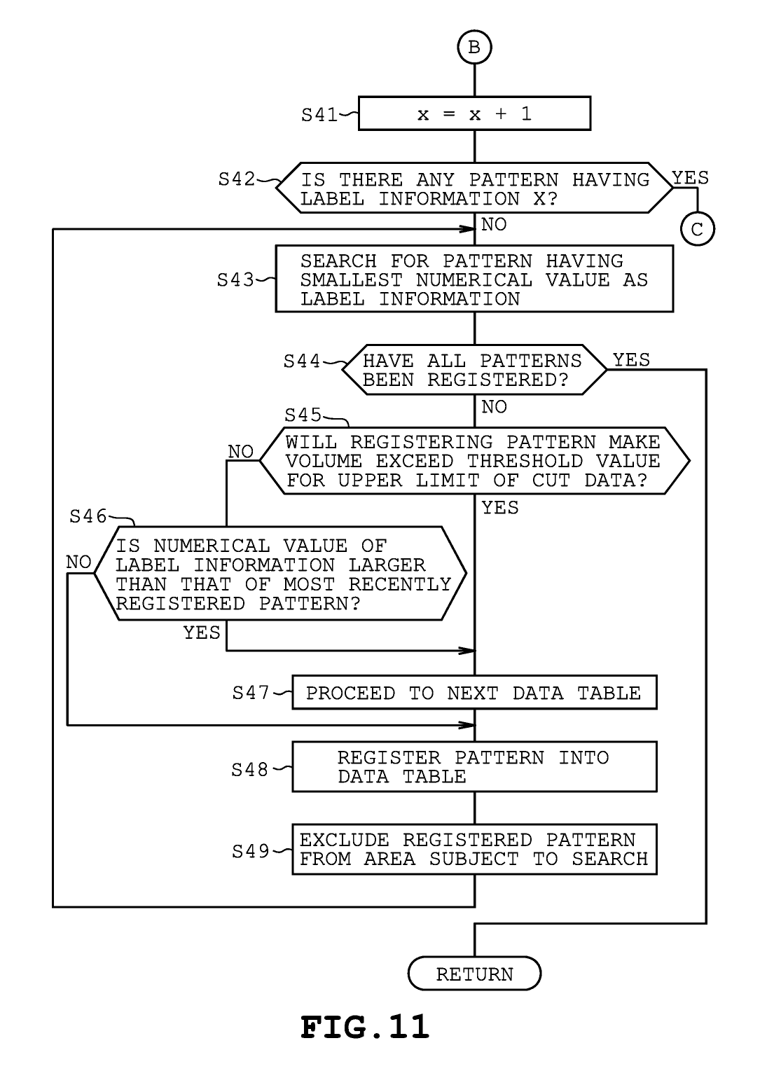

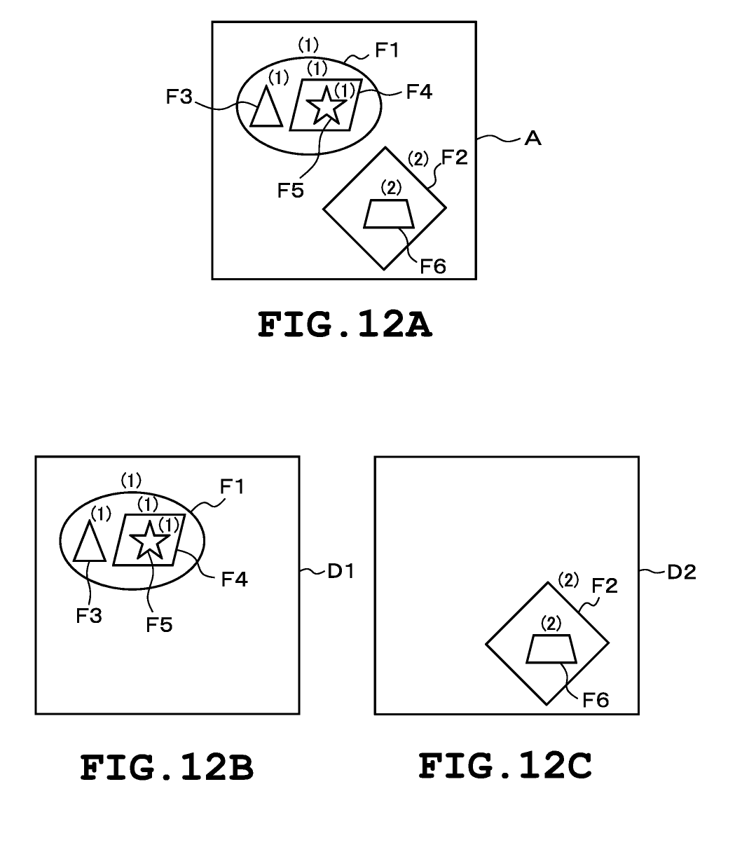

FIGS. 10 to 12 illustrate a second embodiment of the present disclosure. The second embodiment is different from the first embodiment for the process of dividing the cut data into a plurality of divided sections of cut data, i.e., for the process at step S5 in FIG. 6. In other words, in the second embodiment, as illustrated in the flowcharts in FIGS. 10 and 11, a rule different from that in the first embodiment is used as a method for appending pieces of label information. Although the flowcharts shown in FIGS. 10 and 11 are supposed to form a single continuous flowchart, the procedure is shown in the two separate drawings, for a reason related to the space in each of the drawing pages. Further, in the present explanation also, a specific example will be explained in which the patterns F1 to F6, which are the same as those in FIG. 9, are expressed in the cut data as illustrated in FIG. 12.

In FIG. 10, at step S11, the cut data analyzing processing is started. At step S12, the label information X is set to 1. At step S13, the entire area A of the cut data is set as a scan area, i.e., a searched region. At step S14, a search is conducted for a pattern that is formed by an enclosed line and is positioned outermost within the scan area. At step S15, it is judged whether or not the scan has been completed up to the terminal end of the scan area. When the scan has not been completed up to the terminal end (step S15: No), it is judged, at step S16, whether or not there is any pattern.

In the example in FIG. 12A, at first, the first pattern F1 is extracted. In FIG. 10, when there is at least one pattern (step S16: Yes), the label information X is appended to the found pattern at step S17. In that situation, because this is the first scan, the piece of label information appended to the pattern F1 is (1). At step S18, the area inside the found pattern is excluded from the scan area. After that, at step S31 that follows, the numerical value of the label information X is incremented by one, so that the processes from step S15 are repeatedly performed. In the example in FIG. 12A, a piece of label information (1) is appended to the pattern F1, and the region of the pattern F1 is excluded from the scan area. In that situation, because the scan has not been completed up to the terminal end of the scan area A (step S15: No), the scan continues to be performed, so as to extract the pattern F2 (step S16: Yes). At step S17, a piece of label information (2) is appended to the pattern F2. At step S18, the region of the pattern F2 is excluded from the scan area. In that situation, after the pattern F2 is found, the scan is performed up to the terminal end.

When the scan has been completed up to the terminal end of the scan area (step S15: Yes), it is judged, at step S19, whether or not there is any pattern in the set scan area. When there is no pattern (step S19: No), the process is ended.

On the contrary, when there is at least one pattern (step S19: Yes), the label information X is set to (1) at step S32. At step S33, the inside of the pattern having the label information (1) is set as a new scan area. At step S34 that follows, the inside of the scan area is scanned so as to search for patterns. In the example in FIG. 12A, the inside of the pattern F1 is set as a scan rea, so as to search for patterns on the inside thereof.

At step S35, it is judged whether or not the scan has been completed up to the terminal end of the scan area. When the scan has not been completed up to the terminal end (step S35: No), it is judged, at step S36, whether or not there is any pattern. In the example in FIG. 12A, as a result of scanning the inside of the pattern F1, the pattern F4 is extracted. In FIG. 10, when there is at least one pattern (step S36: Yes), the label information X is appended to the found pattern at step S37. In that situation, a piece of label information (1) is appended to the pattern F4. At step S38, the area inside the found pattern is excluded from the scan area, so that the processes from step S35 are repeatedly performed. In the example in FIG. 12A, after the pattern F4 is extracted, the pattern F3 is extracted, and a piece of label information (1) is also appended to the pattern F3.

When the scan performed on the inside of the scan area has been completed (step S35: Yes), it is judged, at step S39, whether or not there is any pattern on the inside of the set scan area. When there is at least one pattern (step S39: Yes), the inside of all the found patterns is set as a new scan area at step S40. Subsequently, the processes from step S34 are repeatedly performed. In the example in FIG. 12A, the inside of the pattern F4 and the inside of the pattern F3 are set as new scan areas so as to search for patterns starting at step S34. As a result, in the example in FIG. 12A, the pattern F5 is newly extracted, and a piece of label information (1) is also appended to the pattern F5.

After that, the inside of the pattern F5 is set as a new scan area. However, because there is no pattern on the inside of the pattern P5, the judgment result at step S39 is “No”. Accordingly, the process proceeds to step S41 in FIG. 11 where the numerical value of the label information X is incremented by one. At step S42, it is judged whether or not there is any pattern having a piece of label information (2). In the example in FIG. 12A, because a piece of label information (2) is appended to the pattern F2, the judgment result at step S42 is “Yes”. Accordingly, the processes from step S33 in FIG. 10 are repeatedly performed. At this time, the inside of the pattern F2 is set as a scan area. The pattern F6 is extracted, and a piece of label information (2) is appended to the pattern F6. When the search has been conducted this far, there is no more pattern, and there is no pattern having a piece of label information (3) appended thereto, either. Accordingly, the judgment result at step S42 in FIG. 11 is “No”, and the process proceeds to step S43.

At step S43, a search is conducted for a pattern that has the smallest numerical value as the label information, among the patterns. In the example in FIG. 12, the piece of label information appended to each of the patterns F1, F4, F3, and F5 is (1). When there are two or more patterns having mutually the same piece of label information, the search is conducted in the order opposite to the order in which the patterns were found, for example. In other words, in this situation, the search is sequentially conducted starting with the pattern F5, which was found recently. At step S44, it is judged whether or not the registration of all the patterns into the data table provided in the EEPROM 54 has been completed. When the registration of all the patterns has not been completed (step S44: No), it is judged, at step S45, whether or not registering the not-yet-registered pattern into the data table will make the volume of the cut data registered in the data table exceed the threshold value.

When the volume will not exceed the threshold value (step S45: No), it is judged, at step S46, whether or not the numerical value of the piece of label information appended to the pattern is larger than the numerical value of the piece of label information appended to the pattern that was registered most recently. When the numerical value of the piece of label information appended to the pattern is equal to or smaller than the numerical value of the piece of label information appended to the pattern registered most recently (step S46: No), the pattern is registered into the data table at step S48. In contrast, when the volume of the cut data will exceed the threshold value (step S45: Yes) or the numerical value of the piece of label information appended to the pattern is larger than the numerical value of the piece of label information appended to the pattern registered most recently (step S46: Yes), the process proceeds to the next data table at step S47. At step S48, the pattern is registered into the data table.

At step S49 that follows, the registered patterns are excluded from the area subject to the search, so that the processes from step S43 are repeatedly performed. In the example in FIG. 12, as illustrated in FIG. 12B, the patterns F5, F3, F4, and F1 each having the piece of label information (1), for example, are sequentially registered into the first data table D1, in the stated order. In this situation, for example, all the patterns F5, F3, F4, and F1 each having the piece of label information (1) are registered into the data table D1. However, depending on the volume of the cut data of each of the patterns, the patterns may be registered as being separated into two data tables. Further, as illustrated in FIG. 12C, the patterns F6 and F2 each having the piece of label information (2) are sequentially registered into the next data table D2, in the stated order. When the registration of all the patterns has been completed in this manner (step S44: Yes), the process is ended.

According to the second embodiment configured in this manner, it is also possible to achieve excellent advantageous effects similar to those in the first embodiment. In particular, in the second embodiment, the divided sections of cut data corresponding to the different regions are obtained in such a manner that the pattern positioned outermost among the patterns found in the search conducted in the searched area and all the patterns positioned within the pattern are organized into a single separated region. It is therefore possible to divide the cut data into sections, with the separation process and the cutting order that can easily be understood by the user.

The present disclosure is not limited to the embodiments described above. It is possible to implement the present disclosure by changing the contents thereof as appropriate within the scope of the disclosure.

For example, the rules used for dividing the cut data into sections are not limited to those explicitly described in the two embodiments above. It is acceptable to use any of other various methods.

Further, it is also acceptable to apply various modifications to the specific configuration of the cutting apparatus 1 such as, for example, detailed configurations of the cut head 5, the cutter cartridge 4, the scanner unit 6, and the like.

In the embodiments described above, the predetermined threshold is a value indicating the upper limit for the data volume processable by the control circuit 51 at a time. However, possible embodiments are not limited to this example. In other words, when the cutting apparatus 1 is configured to perform the cutting process by reading the cut data stored in the EEPROM 54 into the RAM 53, it is acceptable to use the volume of a region assigned within the RAM 53 to be used for processing the cut data, as the predetermined threshold value.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

We claim:

1. A cutting apparatus including a cutting mechanism configured to cut a workpiece, the cutting apparatus comprising:
a controller,
the controller being configured to control the cutting apparatus to:
generate image data by reading a pattern from a surface of the workpiece;
generate cut data used for causing the cutting mechanism to cut the pattern, on the basis of the image data;
store the cut data;
judge whether or not a volume of the cut data exceeds a predetermined threshold value;
divide the cut data into sections each having a volume equal to or smaller than the threshold value when determined that the volume of the cut data exceeds the threshold value; and
cause the storage unit to store therein a plurality of divided sections of cut data, which is a result of the cut data being divided.

2. The cutting apparatus according to claim 1,
the controller being configured to further control the cutting apparatus to:
separate a plurality of patterns formed on the surface of the workpiece into a plurality of regions corresponding to the patterns,
divide the cut data into the divided sections in correspondence with the plurality of regions.

3. The cutting apparatus according to claim 2,
the controller being configured to further control the cutting apparatus to:
separate the patterns in such a manner that one of the regions is included in another one of the regions,
set a cutting order in which the cutting mechanism is to cut a pattern positioned in the one of the regions and a pattern positioned in the other one of the regions, and
divide the cut data into the divided sections according to the cutting order.

4. The cutting apparatus according to claim 3,
the controller being configured to further control the cutting apparatus to:
append pieces of label information to the patterns, in accordance with an inclusion relationship among the plurality of regions, the pieces of label information indicating the cutting order in which the cutting mechanism is to cut the patterns.

5. The cutting apparatus according to claim 4,
the controller being configured to further control the cutting apparatus to:
append the pieces of label information to the patterns so as to indicate the cutting order by which such a pattern that is positioned in an inside region having the inclusion relationship is to be cut first.
